(19) United States
(12) Patent Application Publication
(10) Pub. No.: US 2016/0001858 A1
(43) Pub. Date: Jan. 7, 2016

(54) SUBMERSIBLE OFFSHORE POSITIONABLE FRAME

(71) Applicant: Total Marine Services, Inc., Surrey (CA)

(72) Inventor: Andrew Johnson, Port Moody (CA)

(21) Appl. No.: 14/853,796

(22) Filed: Sep. 14, 2015

Related U.S. Application Data
(63) Continuation of application No. 14/497,230, filed on Sep. 25, 2014, now abandoned.
Application No. 14/497,230 is a continuation of application No. 13/518,848, filed on Jan. 16, 2013, now abandoned.

(51) Int. Cl. B63C 1/12; E02B 17/08; B65G 67/60; E02B 17/02

(52) U.S. Cl. CPC B63C 1/12; E02B 17/021; E02B 17/0809; E02B 17/0836; B65G 67/60

(57) ABSTRACT

A frame comprises a base and at least four legs, wherein said base is positionable along said legs, so that said base may be moved from a first position wherein said base is above a water surface when supported by said legs, to a second position wherein said base is transportable on the deck of a surface vessel.

### CROSS REFERENCE TO RELATED APPLICATIONS

The present application is a continuation of U.S. patent application Ser. No. 14/497,230, filed Sep. 25, 2014, entitled “SUBMERSIBLE OFFSHORE POSITIONABLE FRAME,”which is a continuation of U.S. patent application Ser. No. 13/518,848, filed Jan. 16, 2013, entitled “SUBMERSIBLE OFFSHORE POSITIONABLE FRAME,” which is a 371 U.S. National Phase application of PCT/CA2010/002059, filed Dec. 22, 2010, entitled “SUBMERSIBLE OFFSHORE POSITIONABLE FRAME,” which claims priority to U.S. application Ser. No. 61/289,371, filed Dec. 22, 2009, U.S. application Ser. No. 61/301,575, filed and Feb. 4, 2010, and U.S. application Ser. No. 61/306,360, filed Feb. 19, 2010, the disclosures of which are hereby incorporated by reference in their entirety.

### FIELD OF THE INVENTION

The present invention relates to platforms for offshore construction of wind farms, oil and gas exploration, and other marine construction and salvage operations and the maintenance and decommissioning thereof.

### BACKGROUND

Construction of wind farms, oil and gas fields and other offshore facilities are primarily performed with the use of semi submersible and/or conventional jack up barges or ships that come with high economic costs, and are normally high in demand. Such barges therefore require scheduling well in advance for any given project, and like any other seagoing vessel, can be subject to weather delays that the client economically or by project rescheduling will ultimately pay for.

Conventional jack up barges and ships are typically used for these activities but are very expensive, high in demand and very expensive to mobilize to remote areas of the world. They are adequate for the work but are limited because they are normally built for one particular operation.

It is an object of the present invention to obviate or mitigate the above disadvantages.

### SUMMARY OF THE INVENTION

The present invention comprises a submersible frame comprising a base and at least four legs, said base being positionable along said legs, so that said base may be moved from a first position wherein said base is above a water surface when supported by said legs, to a second position wherein said base is transportable on the deck of a surface vessel.

Unlike a conventional jack up barge, the submersible offshore jack-up frame of the present invention can be out fitted with any local barge suited for the work required from crane service to crew accommodations. For example when building an offshore wind farm, the jack up frame can be utilized with a barge equipped with a 300 ton crane suitable for the placement of pylons, generators and the blades or it could be outfitted with a smaller crane barge used to simply supply man-basket work to support installation or maintenance requirements.

Using the frame of the present invention, any regular local camp barge or fishing lodge can be turned into a suitable offshore accommodation block.

One of the most beneficial aspects of the offshore jack up frame is the ability to accommodate more than one barge for the delivery of components to the hook of the assembly crane out of the tidal zone for any construction activity. Furthermore, when used in combination with more than one supply barge the project activities can take advantage of fair weather by shuttling barges between the offshore work site and the land based supply chain therefore taking advantage of fare weather conditions and potentially reducing the construction schedule by half.

The submersible jack-up platform can easily be transformed into a jack-up crane barge, jack-up accommodation barge, or jack-up supply barge that uses more then one barge to reduce the overall project schedule

Although a normal jack-up barge or ship provide a stable work platform in areas effected by large tidal and weather activities they are limited to the activities they are designed for; ie crane work, transportation of equipment, accommodations or support operations. They are normally very expensive to charter and normally are high in demand with limited availability in many regions of the world and are accompanied with a very expensive mobilization and de-mobilization cost.

When utilizing the submersible jack-up platform a variety of activities can be accomplished throughout the construction phase of any project by changing the barge performing the work. For instance a large crane barge can be utilized for driving large foundation piles, when this activity is complete the large crane barge con be de-mobilized and a smaller crane barge can be utilized to install smaller components as required or once the large crane barge has been demobilized an accommodation barge may be utilized to house additional manpower for larger construction activities. The best part about using the submersible jack-up platform is that it transforms any normal local barge into an economical, easily available jack-up barge ready to perform in tidal and weather restricting areas of the world.

The advantage of using the jack-up support frame over a conventional jack-up barge is the ability to use local equipment and utilize more than one barge to take advantage of fair weather within a tight construction schedule.

### DESCRIPTION OF THE FIGURES

FIG. 1 shows a perspective view of the frame loaded on a barge;

FIG. 2 shows a perspective view of the frame raised from the barge deck;

FIG. 3 shows a perspective view of the frame support on the sea floor;

FIG. 4 shows a perspective view of the frame lowered to support a barge with a crane; and

FIG. 5 shows a perspective view of a frame lifting the barge;

FIG. 6 is a top view of a frame according to the invention;

FIG. 7 is a side view thereof;

FIG. 8 is a front view thereof;

FIG. 9 is a perspective view thereof;

FIG. 10 is a perspective view, showing a barge on the frame, and removing a leg housing 50;

FIG. 11 is a perspective view of a four leg frame;

FIG. 12 is a perspective view of a six leg frame;

FIG. 13 is a perspective view of an alternative embodiment of the invention showing a leg guard;

FIGS. 14a and 14b are top views thereof, showing stabilizer pads;

FIG. 15 is a perspective view thereof;

FIG. 16 is a perspective view of the frame used to install a wind turbine substation or other offshore module;

FIG. 17 is a perspective view of an alternative embodiment of the platform; and

FIG. 18 is a perspective view of submersible jack-up platforms suspended beneath barges.

### DESCRIPTION OF THE INVENTION

The frame of the present invention is a negatively buoyant jack-up structure that may be transported using a supply barge. After the barge delivers the submersible jack-up platform to the erection site, it then shuttles back to port and enters a rotation of several barges supplying components to the erection site. Depending on the distance from port, the quantity of transport barges required to resupply the submersible jack-up platform will vary.

The end goal of the present invention was to develop a vessel that can remain at sea installing turbines indefinitely, store a sufficient supply of turbine components and maintain day-to-day operations while transferring necessary equipment to a given site.

The submersible jack-up platform is a grid work of beams welded or bolted together equipped with four, six, eight or more legs to form a stable platform similar to a conventional jack-up barge but does not have positive floatation. It is used to transform any barge into a suitable jack-up barge for many different construction or decommissioning activities for any given offshore project.

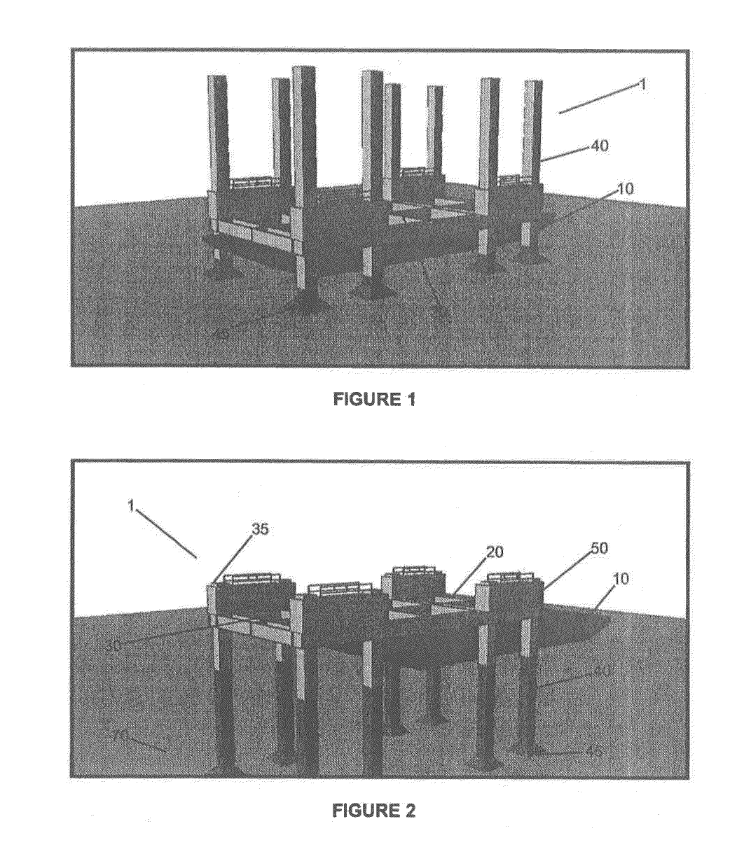

As seen in FIG. 1, frame 1 can be transported by conventional means, such as barge 10. Frame 1 includes a grid work of metal, such as steel or aluminum, beams 20, arrayed to form base 30. In an alternative embodiment, base 30 could also be a largely solid, but must contain apertures to allow water to pass through base 30. Base 30 must be sufficiently strong to support a barge 10 and what is on the deck of barge 10. Base 30 is constructed to allow base 10 to submerge naturally, i.e. have a non buoyant structure.

Frame 1 includes legs 40, which end with foot 45. At least three legs 40 should be present, although eight legs 40 will provide more support. Alternatively, six, ten, twelve or more legs 40 may be present. Legs 40 may be made of steel. Foot 45 may also be made of steel. Legs 40 pass through base 30 at apertures 35. On base 30 to assist in supporting legs 40 are leg housing 50. Leg housing 50 may include a watertight machinery compartment which holds the generators, hydraulic power pack and pump. Leg housing 50 also includes the jacks and locking mechanism to position base 30 and hold base 30 in position relative to legs 40. Each leg housing 50 can support one or more legs 40. Leg housing 50 includes apertures 55 through which are positioned legs 40 and are aligned with apertures 35. Railings 60, walkways, mooring systems, safety systems (such as lifeboats) may be positioned on leg housing 50 and/or base 30. Leg housing 50 may be 20 to 25 feet tall and should be taller than barge 10.

Leg housing 50 holds the base positioning apparatus, including generators, hydraulic power pack, pump, jacks and locking mechanism. Base positioning apparatus are available from companies such as GustoMSC™. These allow base 30 to be positioned vertically along legs 40 as selected by the user. Base 30 can be positioned so that most of the length of leg 40 is above leg housing 50, as shown in FIG. 1. At this position, base 30 can be easily transported by barge 10 or the like.

Generators in leg housing 50 may be used to provide redundancy for one another. If one fails, the generators in another leg housing may be used.

Control room 70 may be placed on leg housing 50 or base 30 to allow operation of frame 1. Capture mechanisms 80, such as a hydraulic or nitrogen hydraulic cylinder may be used to hold barge 10 in place and provide downward force thereto. Connection 85 is secured to corresponding pin and lug connection on barge 10, and downward force is applied to help hold the barge. These are also useful when transporting frame 1. In such a case, capture mechanism 80 suspends frame 1 beneath a barge 10, which can then be transported after legs 40 are elevated relative to base 30.

Also barge 10 may be welded to frame 1, which may be appropriate for long term operations.

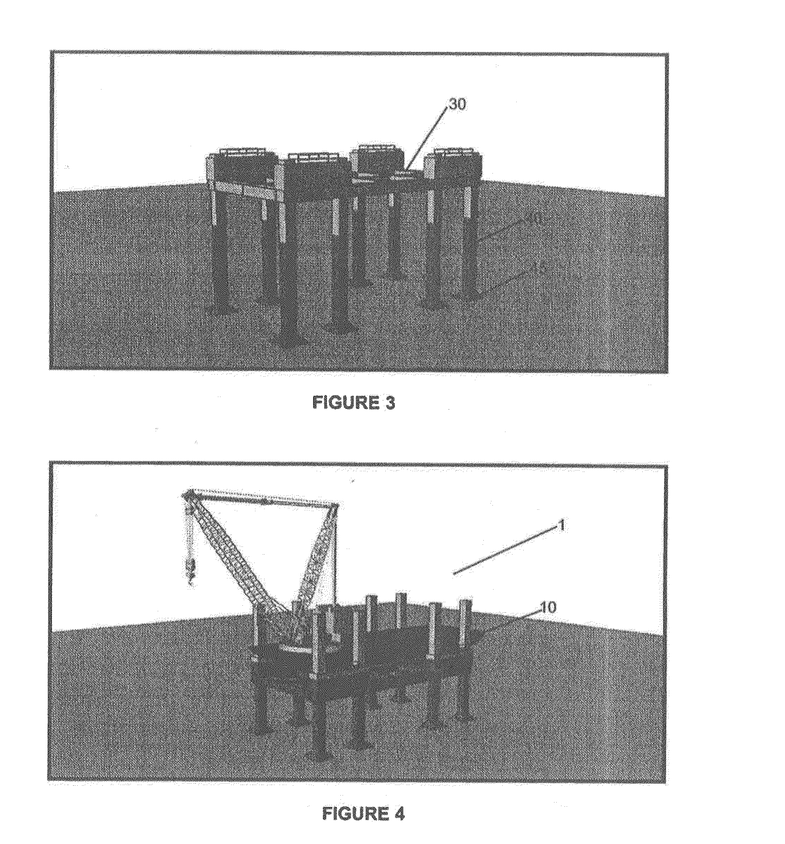

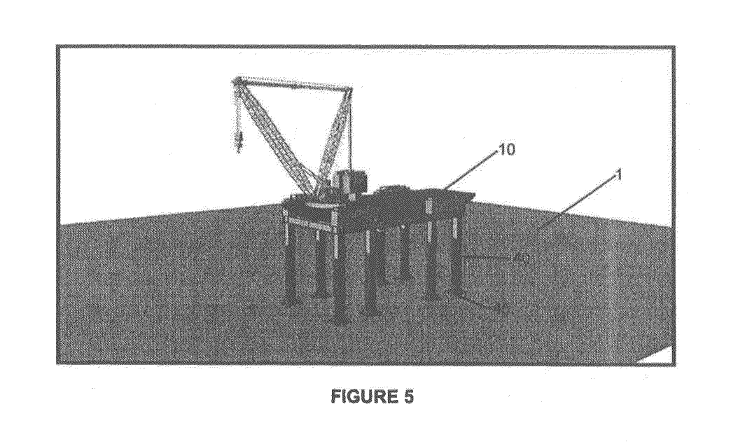

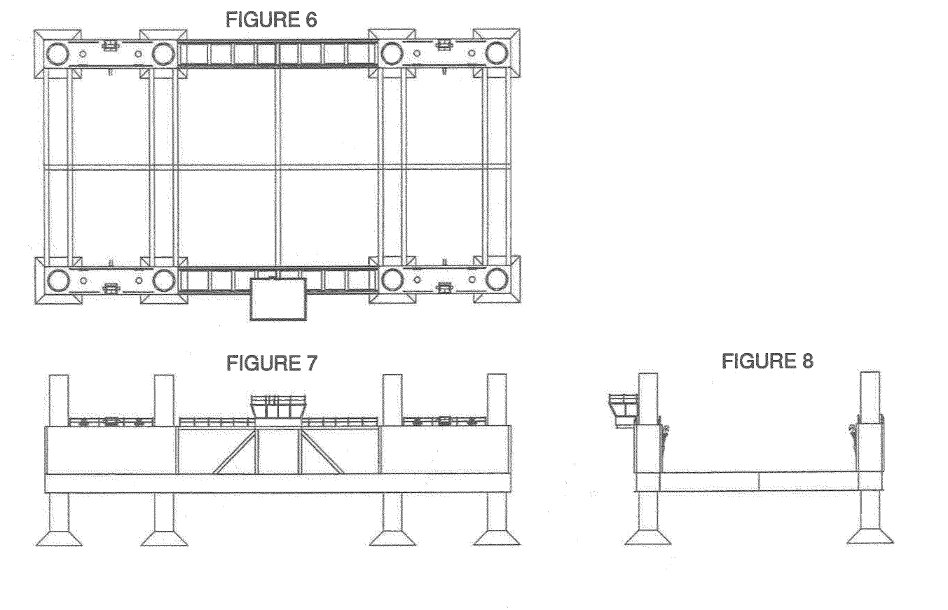

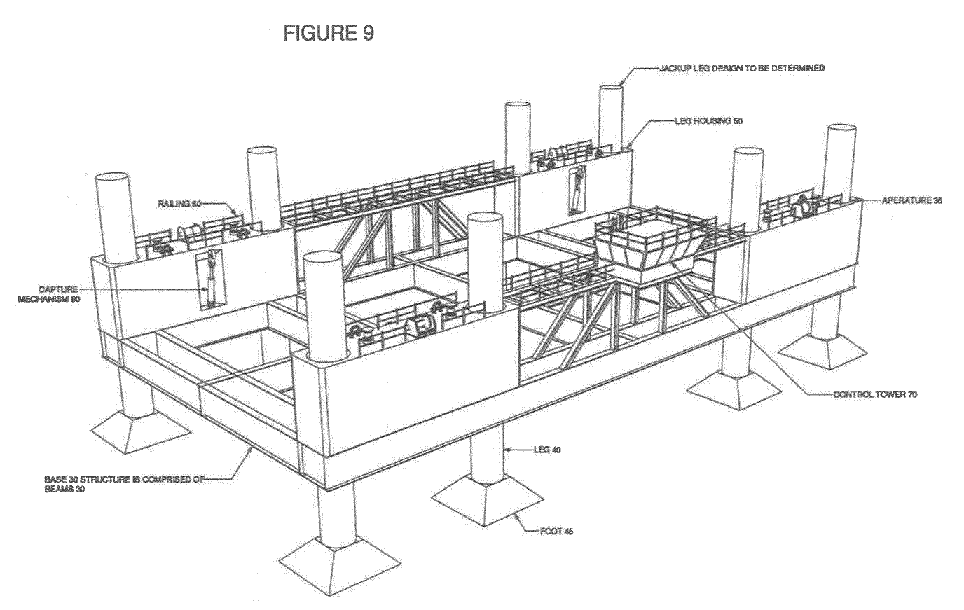

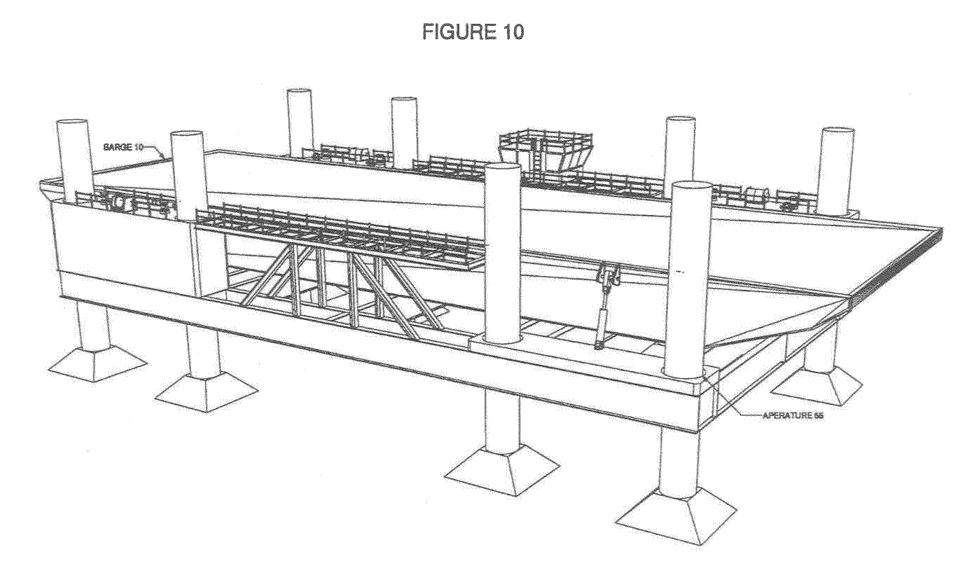

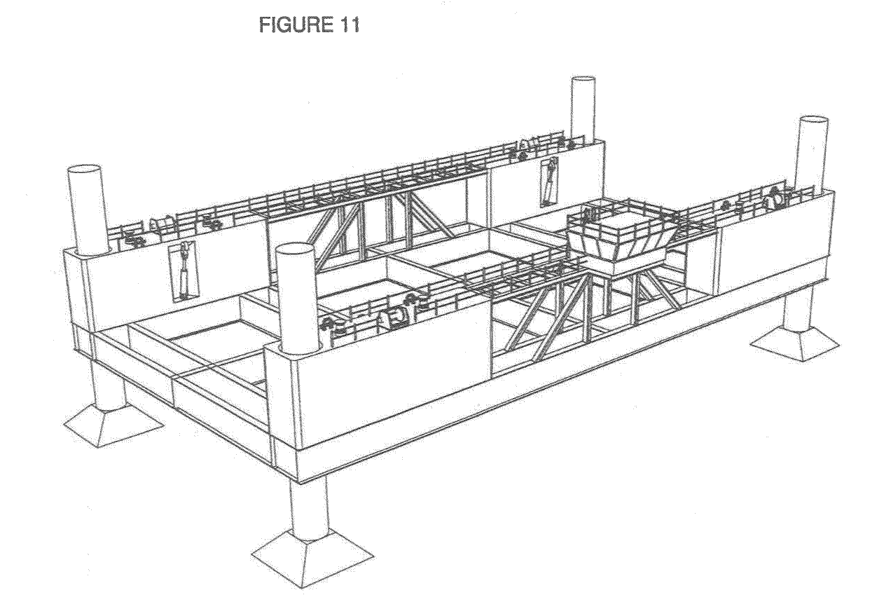

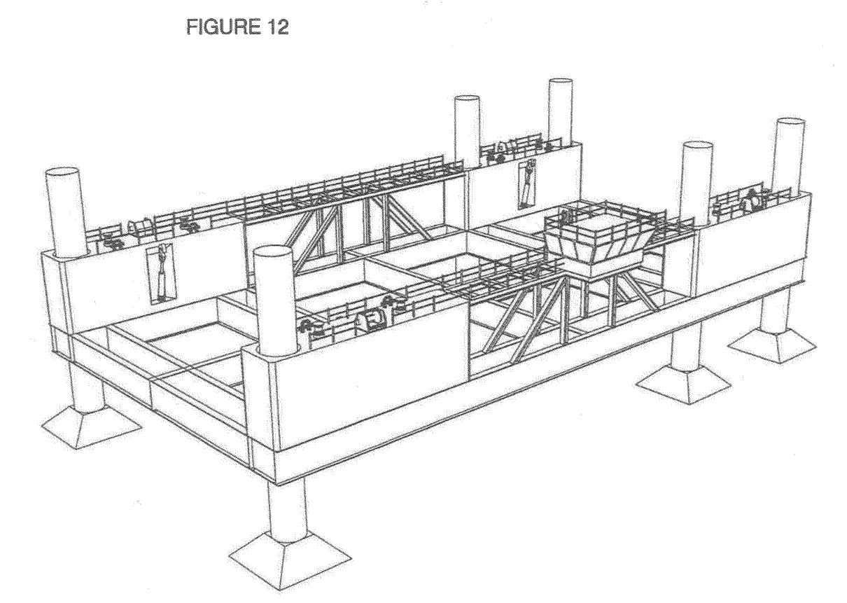

As shown in FIG. 2, base 30 can be positioned so that legs 40 are almost entirely below base 30. At an appropriate height, base 30 may be positioned above the sea level enough so that barge 10 may pull away (i.e. base 30 is elevated above the deck of barge 10). At such a height legs 40 rest on the sea floor 70. FIG. 3 shows base 30 after barge 10 has pulled away.

Frame 1 can be used to support heavy equipment, such as crane 80. To position such equipment, first, crane 90 is transported by barge 10 to the location of frame 1. Base 30 is then lowered so that barge 10 can be positioned above base 30, as shown in FIG. 4. Base 30 can then be elevated so that it lifts barge 10 and crane 90 thereupon, out of the water.

In an embodiment of the invention, barge 10 is sized to fit base 30. In this embodiment, the width of barge 10 should fit snugly on base 30 between leg compartments 50. Beams 20 may, on their upper surface, have a dampening layer, such as rubber, to hold barge 10 in position and minimize damage on contact.

When base 30 is submerged, the upper surface of leg housing 50 may be above the water surface to allow for flood prevention and venting, and to protect the positioning apparatus and onboard personnel.

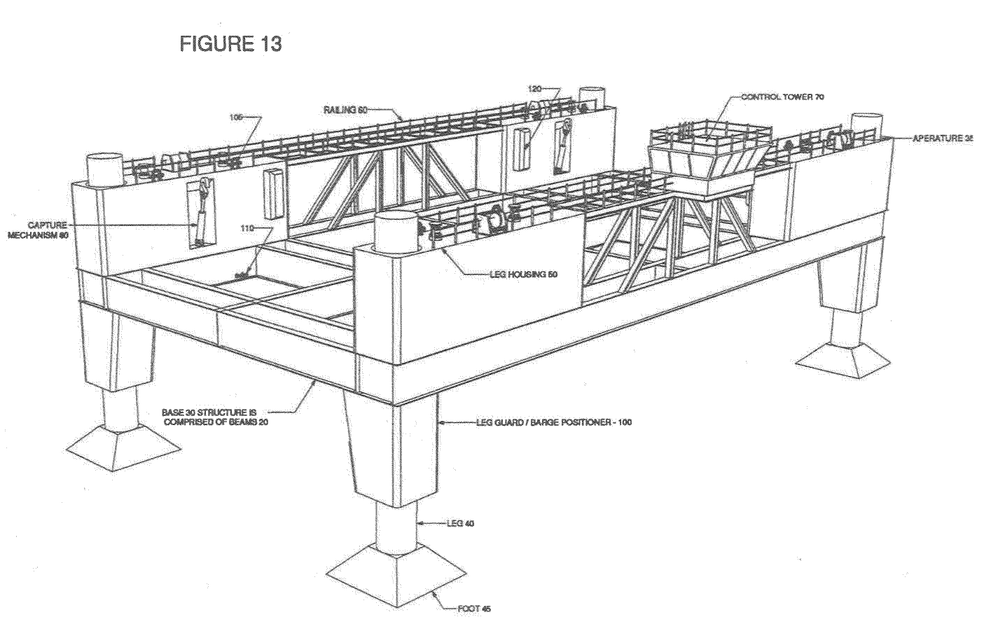

As seen in FIG. 13, legs 40 may be protected by leg guard 100, to prevent barge 10 from damaging leg 40. Leg guards 100 extend below base 30 to a position above foot 45. Leg guards 100 widen as they approach base 30, and thereby serve to hold barge 10 in position when barge 10 is below base 30 as well as center barge 10 relative to base 30. Leg guards 100 are fixed in position and can serve to indicate when leg 40 is being raised, that feet 45 are approaching guard 100.

Moorage chaulks 105 are positioned on leg compartment 50 to allow rope to be strung from chaulks 105 to ballards on barge 10 when barge 10 is positioned on base 30. Lower chaulks 110 are positioned on the side of base 30 facing inwardly, to allow rope to be strung from chaulks 110 to the ballards when barge 10 is positioned below base 30. In an embodiment of the invention, lower chaulks 110 may be vertically aligned with chaulks 105.

In another embodiment, sea fastening may be used to prevent barge 10 from moving in any direction, including forwards or backwards, and up or down, relative to base 30. Such sea fastenings could include jacks, turnbuckles, pipes beams or other means.

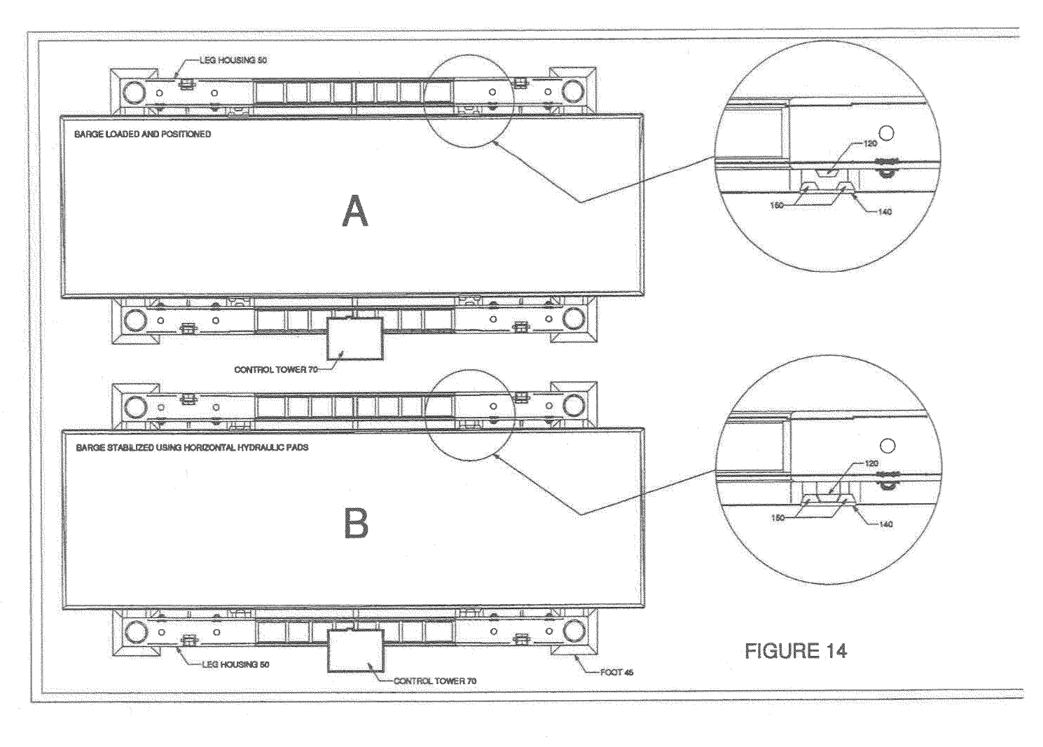

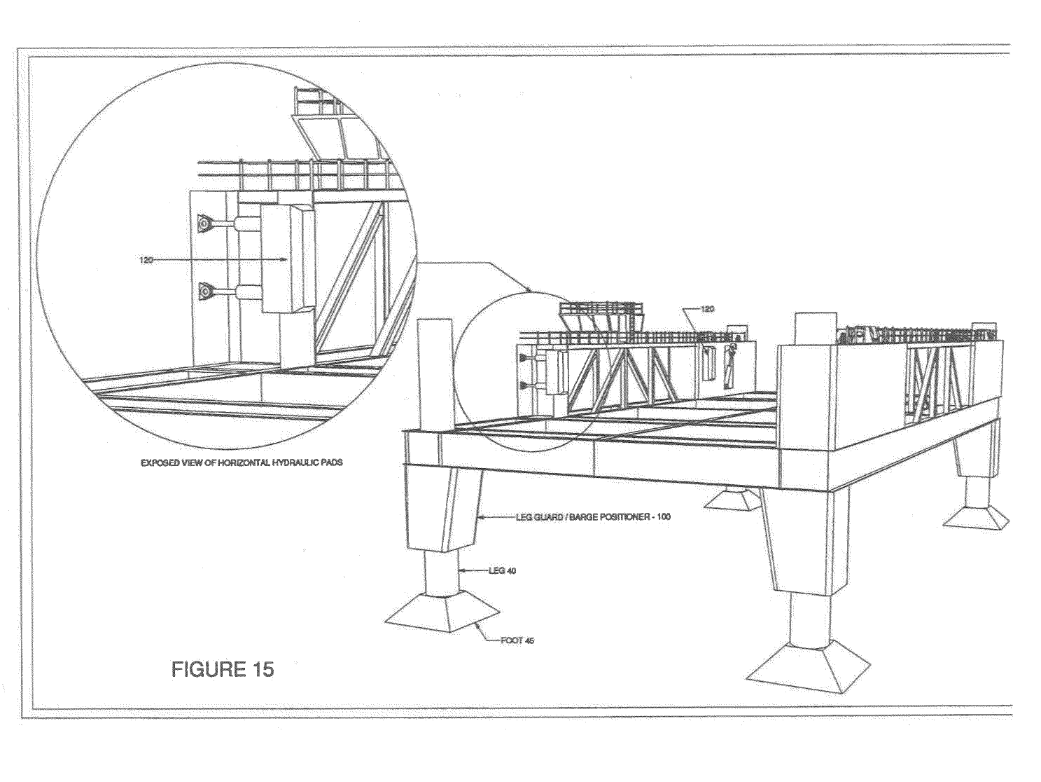

FIGS. 14a, 14b and 15, show horizontal stabilizing pads 120. Pads 120, as shown in FIGS. 14a and 14b are retractable, and may be moved from a unextended to an extended position when barge 10 is in position. Barge 10 may include stabilizing plate 140. Stabilizing plate 140 includes ridges 150 running vertically along plate 140. Pads 120 are shaped to fit between ridges 150 and when in place, prevent barge 10 from moving horizontally, while allowing vertical movement. To prevent vertical movement, pads 120 hold barge 10 in position to allow capture mechanism 80 to be actuated and prevent such movement.

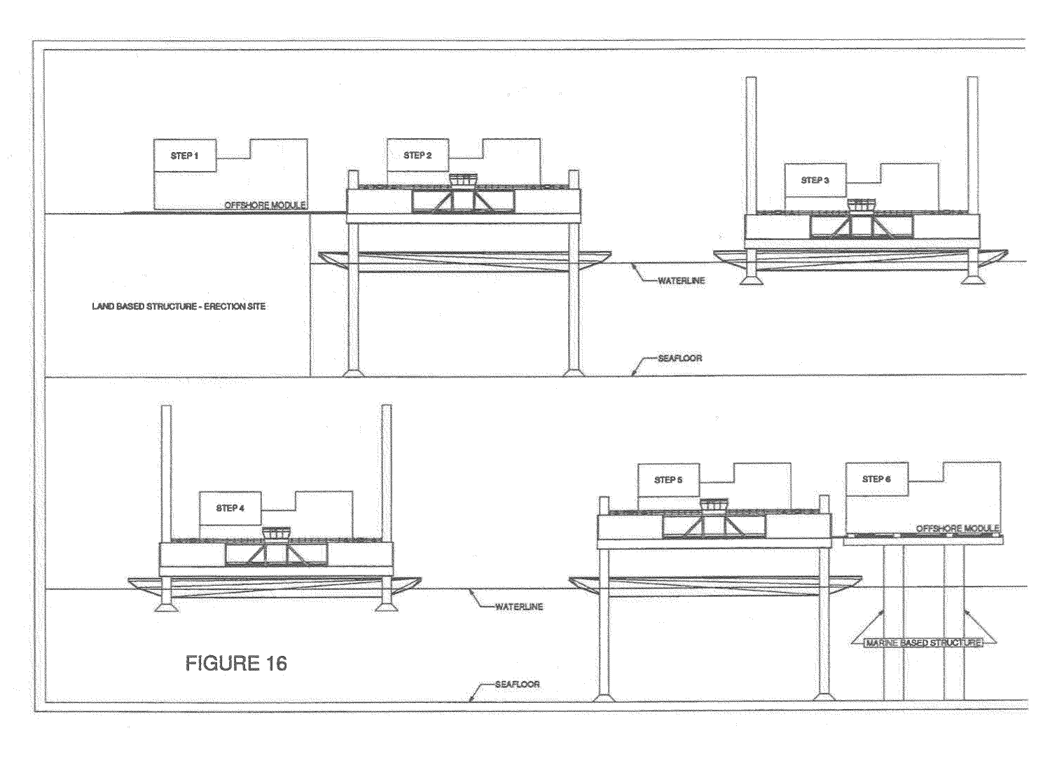

Besides barges 10, frame 1 could be used along with skidding operations, and could be used in transporting offshore structures, such as oil field topside modules or wind turbine substations (as shown in FIG. 16), and may also be used in salvage operations to retrieve sunken objects.

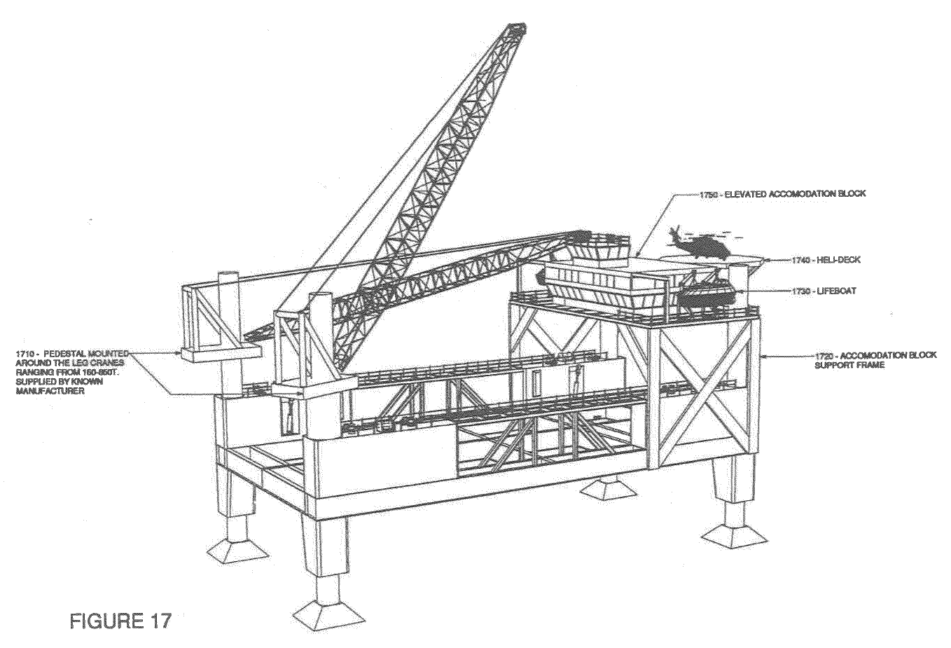

FIG. 17 shows an alternative embodiment of frame 1, wherein frame 1 further includes cranes 1710. Cranes 1710 are supported by a pedestal mount around legs 40 and on top of leg housing 50. Also present is frame 1720, which supports control room 70, lifeboat 1730, helicopter landing pad 1740, and accommodation block 1750. Accommodation block 1750 and frame 1720 can be made of conventional materials, such as aluminum or steel.

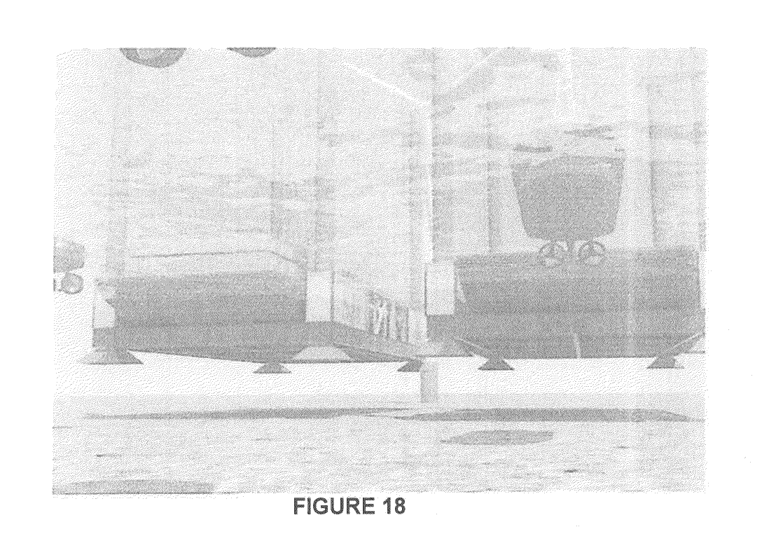

FIG. 18 shows submersible jack-up platform (SJP) frames suspended beneath barges. The hydraulic system used to re-capture supply barges will also act as a locking mechanism between the SJP and the barge. By this mechanism, the frame can be moved short distances, for example between turbine locations. Rather than transport the frame on an empty barge deck, the SJP simply retracts its legs and suspends underneath the barge.

### EXAMPLE 1

Wind Farm Component Installation

Within one aspect of the present invention, there is provided a basic arrangement involving two separate units, one for equipment and accommodations and the other for turbine component supply. The supply barges eliminate the time and distances traveled to and from port, and the loading and unloading times that would normally be performed by the installation vessel. All of that time is converted into more turbines being installed on site. With the two unit arrangement, the components are lifted and installed directly from the supply barges. Another advantage to using supply barges is that deck space becomes more readily available to transport larger items. As a result, more components can be assembled in port to reduce turbine erection times offshore.

The SeaHoist frame of the present invention allows for a variety of different configurations, all depending on the size and location of the offshore wind farm. For example, a small project relatively dose to port might only use a single submersible jack-up platform to lift barges carrying both installation equipment and components at the same time. Another scenario might show a submersible jack-up platform being used as a feeder vessel to support one of the larger Turbine Installation Vessels (TIVs).

Another possibility for larger projects might involve a series submersible jack-up platform at several different turbine locations. The barges might then be equipped for specific jobs such as installing monopiles, transition pieces etc. and bounce along from submersible jack-up platform to submersible jack-up platform performing each specific task. That way several turbines could be erected simultaneously, much like a production line.

In contrast to the prior known concepts, another possibility is to outfit the submersible jack-up platform with around the leg cranes and accommodations. This would enable the offshore contractor to conduct all activities from a single platform, much like a large jack-up vessel. The difference is the continuous supply chain feeding the submersible jack-up platform, allowing installation efforts to be carried out 24 hours a day, 7 days a week. This arrangement would allow contractors to reduce the time intervals between installation phases by preparing equipment and components before needed. Cumulatively, the time saved over the duration of an entire project would be considerable.

In addition to the Offshore Turbine Installation, the submersible jack-up platform could also be used to install substations. A substation may be loaded directly onto the main frame by using skid gear. Once secure, the submersible jack-up platform may then jack down to the deck of a transport barge, and retract its legs clear of the seafloor. Upon arriving on site, the submersible jack-up platform would jack up to level height with the substation platform, and skid the unit into place. This same technique could be used for certain operations in the offshore oil and gas industry, salvage operations, or even as a dry dock.

I claim:

1. A jack-up structure for elevating a barge above water level which comprises:
a) a non-buoyant, barge-engaging base;
b) a plurality of legs;
c) a drive mechanism;
said base engaged with said legs such that the base is movable, via the drive mechanism, vertically along said legs, from a first position, (which is selected from the group consisting of at water level and under water level) to a second position elevated above water level; said structure having means i) to removably engage the barge and the base at the first position ii) to secure barge on the base for movement to the second position; ii) to move base (carrying the barge) between the first position and the second position.

2. The structure of claim 1 wherein said base comprises a plurality of beams forming an array.

3. The structure of claim 1 wherein said barge supports heavy equipment.

4. The structure of claim 1 wherein said barge supports a crane.

5. The structure of claim 1 further comprising a leg guard for each of said legs.

6. The structure of claim 1 further comprising retractable stabilizing bars, said bars when extended being shaped to be received by ridges positioned on said barge, to prevent horizontal movement of said barge.

7. The structure of claim 1 wherein said base is transportable on a deck of a surface vessel.

8. The structure of claim 1 wherein the legs are extendable to engage a water bed.

9. The structure of claim 1 comprising a barge locking mechanism to secure the barge in place on the base.

10. The structure of claim 1 wherein the base is positionable and securable at any vertical point on said legs.

11. The structure of claim 1 wherein the base is substantially solid and comprises at least one water-passing aperture.

12. The structure of claim 1 wherein the barge is welded to the base.

13. The structure of claim 1 comprising a base positioning apparatus.

14. The structure of claim 1 comprising a generator.

15. The structure of claim 1 comprising a hydraulic power pack.

16. The structure of claim 1 comprising a jack and jack-locking means.

17. The structure of claim 1 which is adapted to be carried, in water, under the barge.

18. A system for off-shore construction which comprises:
a) a jack-up structure for elevating a barge above water level which comprises:
i) a non- buoyant, barge-engaging base;
ii) a plurality of legs;
said base engaged with said legs such that the base is movable, vertically along said legs, from a first position (which is selected from the group consisting of at water level and under water level) to a second position elevated above water level; said structure having means i) to removably engage the barge and the base at the first position ii) to secure barge on the base for movement to the second position; ii) to move base (carrying the barge) between the first position and the second position;
b) a plurality of supply barges which each, sequentially:
i) with a payload, engage with the base at a first position;
ii) are elevated on the base to the second position;
ii) are relieved of the payload;
iv) are returned to the first position on the base; and
v) are disengaged from base.

19. A method of conveying supplies to an off-shore site of a project which comprises:
a) setting up at the off-shore site at least one jack-up structure for elevating a barge above water level which comprises:
i) a non-buoyant, barge-engaging base;
ii) a plurality of legs;
said base engaged with said legs such that the base is movable, vertically along said legs, from a first position (which is selected from the group consisting of at water level and under water level) to a second position elevated above water level; said structure having means i) to removably engage the barge and the base at the first position ii) to secure barge on the base for movement to the second position; ii) to move base (carrying the barge) between the first position and the second position;
b) engaging a first payload carrying barge with the base in the first position such that the base is disposed upon the base;
c) securing the barge on the base;
d) elevating the base to the second position;
e) removing the payload;
f) lowering the base carrying the empty barge to the first position;
g) disengaging the barge from the base;
h) engaging a second payload carrying barge with the base in the first position such that the base is disposed upon the base; and
i) repeating steps c) to g) for the second payload carrying barge.
